(19) United States
(12) Patent Application Publication
(10) Pub. No.: US 2015/0207287 A1
(43) Pub. Date: Jul. 23, 2015

(54) TWISTED EN-PLATED TERMINAL FOR HIGH CURRENT MOSFET TERMINATIONS

(71) Applicant: Remy Technologies LLC, Pendleton, IN (US)

(72) Inventors: Alex Creviston, Muncie, IN (US); Ronald Gentry, Cicero, IN (US); Christopher Bledsoe, Anderson, IN (US)

(21) Appl. No.: 14/161,044

(22) Filed: Jan. 22, 2014

(51) Int. Cl. H01R 43/02; B23K 1/00

(52) U.S. Cl. CPC H01R 43/0214; B23K 1/0004

(57) ABSTRACT

A method includes resistance brazing using high-phosphorous electroless nickel (EN) plating both as a resistance path and as a flux. A method for fixing an electrical terminal to a pair of copper conductor bus strips includes the steps of plating the electrical terminal with high-phosphorous EN, placing the EN-plated terminal between the bus strips, and resistance brazing the terminal to the bus strips using the EN plating both as a resistance path and as a flux. A method of providing a high current electrical connection includes the steps of extending a terminal from a bottom surface of an electrical module, plating the terminal extension with high-phosphorous EN, placing a bus conductor into abutment with the plated terminal extension, and resistance brazing the bus conductor to the plated terminal extension using the high-phosphorous electroless nickel as a resistance path.

### BACKGROUND

The present invention is directed to high current electrical connections and, more particularly, to structure and methods for attaching a conductor to a power terminal.

Metal-oxide-semiconductor field-effect transistors (MOSFETs) are often utilized in automotive electronics subassemblies such as those designed for implementing generating and motoring functions of an alternator-starter. Power MOSFETs may be packaged in power electronic modules as part of a rectifier/inverter circuit, the MOSFETs typically being arranged in a bridge configuration for rectifying an alternating current (AC) in generating mode in order to provide a direct current (DC) to charge a battery, and forming an inverter for transforming DC voltage into multiple-phase AC voltage in motoring mode to provide starting motor torque. For example, motoring currents in a cranking operation may be 1200 Amperes or greater.

The terminals of power MOSFETs and/or power electronics modules have been connected to one another and to other electrical components using bus conductors that are attached to these power terminals by welding, brazing, soldering, terminal devices, crimp connectors, lugs, wire, and by other structure. Such connection methods and structure are not optimized for high current capacity, reliability, or for efficient manufacturing.

### SUMMARY

It is therefore desirable to obviate the above-mentioned disadvantages by providing a method of bonding a high-current conductor to a terminal of a power electronic module.

According to an exemplary embodiment, a method includes resistance brazing using high-phosphorous electroless nickel (EN) plating both as a resistance path and as a flux.

According to another exemplary embodiment, a method for fixing an electrical terminal to a pair of copper conductor bus strips includes the steps of plating the electrical terminal with high-phosphorous electroless nickel (EN), placing the EN-plated terminal between the bus strips, and resistance brazing the terminal to the bus strips using the EN plating both as a resistance path and as a flux.

According to a further exemplary embodiment, a method of providing a high current electrical connection includes the steps of extending a terminal from a bottom surface of an electrical module, plating the terminal extension with high-phosphorous electroless nickel, placing a bus conductor into abutment with the plated terminal extension, and resistance brazing the bus conductor to the plated terminal extension using the high-phosphorous electroless nickel as a resistance path.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a perspective view of a power electronics module 1, according to an exemplary embodiment;

FIG. 2 is a partial perspective end view of an alternator-starter, according to an exemplary embodiment; and

FIG. 3 is an elevation view of a brazing assembly 48, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

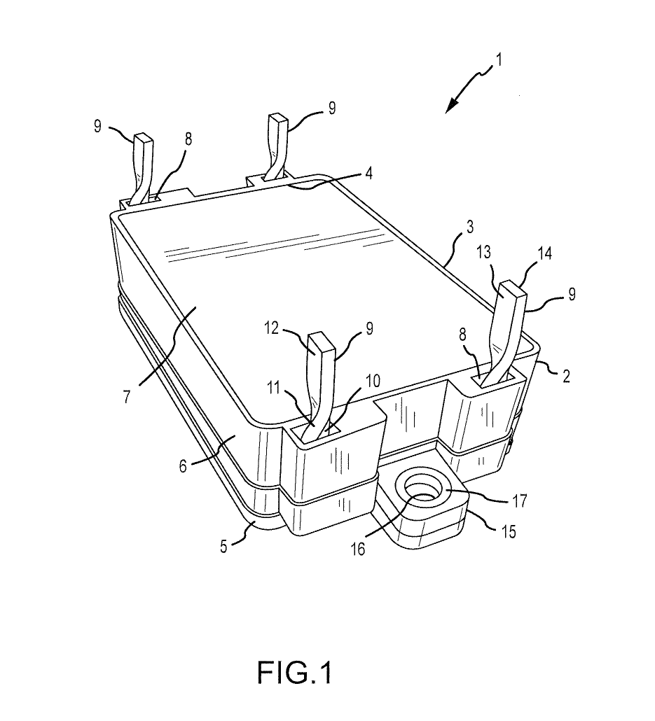

FIG. 1 is a perspective view of a power electronics module 1, according to an exemplary embodiment. Module 1 may include two power MOSFET devices (not shown) within a generally rectangular case 2 having two parallel long sides 3 and two parallel short sides 4. Case 2 may be formed by assembling individual portions. For example, a module mounting plate 5 may have a high thermal conductance for efficient heat transfer, an enclosing portion 6 may be formed of a light weight, high strength resin for providing structural integrity, and a potting portion 7 may be filled for hermetically sealing the electronic components within module 1 after the internal circuitry has been installed and tested. Mounting plate 5 may be formed as a single conductor, as any number of individual conductors electrically insulated from one another, or as an electrically non-conductive surface. For example, mounting surface 5 may be in electrical communication with one or more terminals of power electronics components contained within module 1. Each short side 4 of enclosing portion 6 includes two terminal holes 8, each sized to permit a metal terminal 9 to extend therethrough. The four terminals 9 each have a substantially rectangular cross-sectional profile and each include an internal portion 10 enclosed by case 2, a twisted portion 11, and a terminal extension 12 that projects from case 2 so that the cross-sectionally long sides 13, 14 of terminal extension 12 are substantially in parallel with long sides 3 of case 2.

Module 1 may include a mounting portion 15 having a mounting hole 16 and an insert 17. As described further by example below, module 1 may be secured to the housing of an alternator-starter with a threaded fastener that passes through hole 16 and mates with a corresponding threaded housing receptacle. Insert 17 may act as a washer/spacer, provide structural support, provide an electrical conductor, and may be formed with or without threads.

Each terminal extension 12 is plated using high-phosphorous Electroless Nickel (EN). Terminal extensions 12 are cleaned and dried before being plated, whereby excellent adhesion of the nickel-phosphorous plating to terminal extensions 12 is obtained. The EN plating operation is an auto-catalytic process that forms a layer of nickel-phosphorous on each terminal extension 12. The electroless process does not require passing an electric current through a solution but, instead, utilizes a reducing agent that reacts with metal ions to thereby deposit metal on terminal extension 12. For example, a reducing agent may include sodium hypophosphite, dimethyl amino borane, sodium borohydride, formaldehyde, or another compound such as potassium hypophosphite or ammonium hypophosphite. The EN plating bath may variously contain silicon carbide, silicon nitride, ammonia, and other materials such as a metal ion complexing agent, a pH buffer, a stabilizer, and/or a surfactant, in relatively small quantities. Terminal extensions 12 are placed into the EN plating bath for a period of time, until the thickness of the resultant plating is approximately 2.5 microns. Generally, the thickness of the plating increases with time in the bath.

Various EN plating methods may be used to achieve fifteen percent phosphorous in the plating deposited on terminal extension 12, the EN plating operation usually requiring tight tolerances for bath composition and process parameters. Sodium hydroxide may be used to maintain a constant pH of the plating solution. Electroless plating occurs by two simultaneous half reactions involving electron generation and electron reduction. The metal ions in the solution accept electrons at the deposition surface, become reduced, and are deposited as metal on the surface of the workpiece.

The metal surfaces of terminal extensions 12 are prepared by thorough cleaning with a mild acid or etch. An exemplary electroless nickel plating bath contains approximately six grams per liter of nickel and uses sodium hypophosphite as the reducing agent. The temperature is maintained at 82-92 degrees Celsius, and the pH is maintained between about 4.6 to 5.0. The resultant phosphorous content may be up to about fifteen percent by mass. Generally, a faster plating rate results in a higher percentage of phosphorous. A higher plating rate may be obtained, for example, by adjusting chelate and stablizer mixtures. It is possible to raise the plating rate to about 0.7 mil/hour, but an increased rate may cause deposit properties to change. When polyphosphate salts or polyphosphoric acid is added to the bath, more phosphorous may be deposited, whereby the plating has a smaller granularity and is more amorphous. During the plating process, terminal extensions 12 are secured into an immersion fixture (not shown), immersed in the plating bath, and agitated slightly. Alternatively, electrolytic plating, vapor deposition and/or sputtering may be utilized for depositing a nickel-phosphorous composition onto terminal extensions 12. The resultant very-high phosphorous EN plating is typically brittle and may be subject to flaking. These physical properties at a high phosphorous content may be detrimental when an EN plating is a coating on a finished product, but such properties may actually enhance and improve a subsequent resistance brazing of EN-plated terminal extensions 12, described further below.

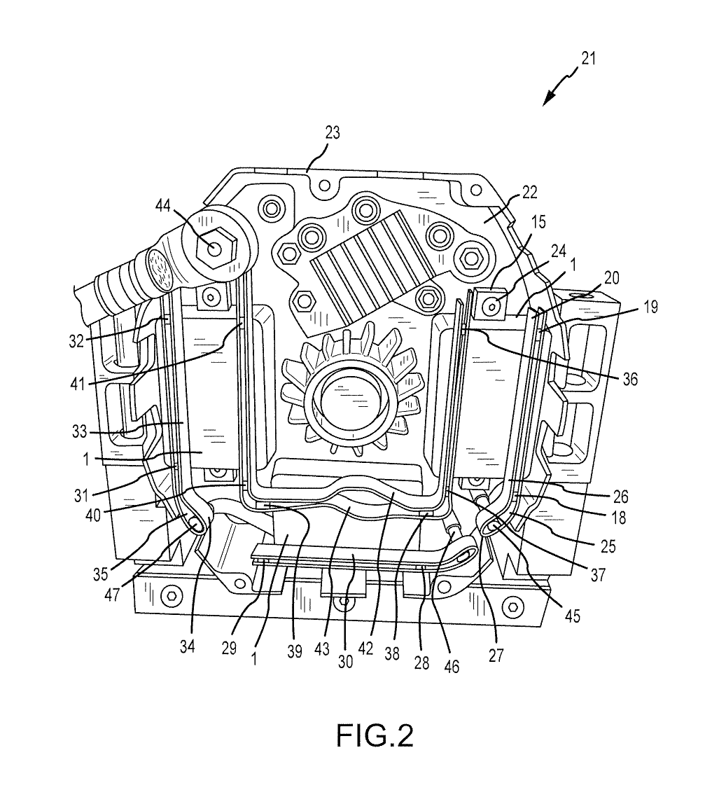

FIG. 2 is a partial perspective end view of an alternator-starter 21, according to an exemplary embodiment. Three separate power electronic modules 1 are each mounted to a surface 22 of a cast housing 23 with fasteners 24 that are secured at respective mounting portions 15. Terminal extensions of each module 1 extend axially and are sandwiched between a pair of flat bus conductor strip portions. The bus conductor strips each have a rectangular cross-sectional profile. A conductor strip 20 is folded back on itself at a fold 27, thereby sandwiching terminal extensions 18 and 19 between the long-cross-sectional side of conductor strip portion 25 and the long-cross-sectional side of conductor strip portion 26. The surface area at each terminal abutment is maximized. In particular, with reference to FIG. 1, each terminal extension's respective cross-sectionally long sides 13, 14 are placed into abutment with corresponding long-cross-sectional surfaces of conductor strip portions 25, 26. In like manner, terminal extensions 28, 29 are sandwiched between substantially parallel portions of conductor strip 30. In like manner, terminal extensions 31, 32 are sandwiched between substantially parallel portions 34, 35 of conductor strip 33. In the disclosed exemplary embodiment, the respective cross-sectionally long sides 13, 14 of the remaining terminal extensions 36-41 are sandwiched between substantially parallel portions of conductor strips 42, 43. Depending on the electrical configuration within power electronic modules 1, any of conductor strips 33, 42, 43 may be electrically connected to a B+ terminal post 44. In addition, any number of electrical wires may be sandwiched between any of the conductor strip portions. For example, phase leads 45-47 are shown respectively connected to conductor strips 20, 30, 33.

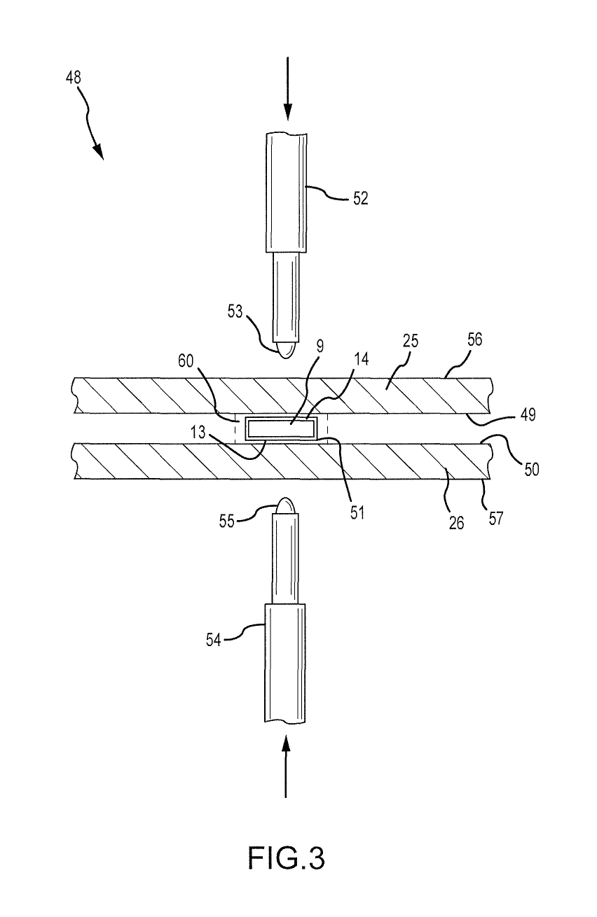

FIG. 3 is an elevation view of a brazing assembly 48, according to an exemplary embodiment. Electronic module terminal 9 has a rectangular cross-sectional profile with a first long side 14 and a second long side 13. Terminal 9 has been EN plated with a nickel-phosphorous alloy plating 51 that is approximately 2.5 microns thick and has phosphorous content of approximately fifteen percent by weight. Plated terminal 9 is sandwiched between conductor strip portions 25, 26 so that inner edge 49 of conductor portion 25 is substantially parallel to terminal side 14 and inner edge 50 of conductor portion 26 is substantially parallel to terminal side 13. A first electrode 52 has a tip 53 and a second electrode 54 has a tip 55. Electrodes 52, 54 are part of a resistance welding/brazing machine (not shown), such as a mid-frequency inverter type machine. Electrodes 52, 54 are moved by the brazing machine so that tip 53 contacts the outer surface 56 of copper conductor strip portion 25 and so that tip 55 contacts the outer surface 57 of copper conductor strip portion 26. Tips 53, 55 may have any appropriate size and shape.

Electrodes 52, 54 are moved toward one another with force, and the electric current of the brazing machine is turned on for a duration of approximately 0.25 seconds. Typically, the electric current is at least 1000 Amperes, for example 10,000 Amps for a ⅛ square inch area (e.g., 0.5×0.25). In the resultant resistance welding/brazing, the locations having the greatest electrical resistance along the current path create heat. In particular, the heat at the high resistance locations is sufficient to melt EN plating 51, whereby terminal extension surface 14 is bonded to copper conductor inside surface 49 and terminal extension surface 13 is bonded to copper conductor inside surface 50. Electrodes 52, 54 may remain biased toward one another after the electrical current has been turned off, so that the bonding of surfaces and the flow of EN plating material 51 stops and a resultant alloy has cooled into a stable solid. Electrodes 52, 54 may contain coolant passages (not shown) for active removal of heat after the brazing process. Ancillary structure (not shown) may be provided for biasing and/or securing conductor strip portions 25, 26 before, during, or after the flow of brazing current.

Since electrodes 52, 54 only contact the outside copper conductor surfaces 56, 57, the melted EN material flows out of the interfaces between terminal 9 and inner copper conductor surfaces 49, 50. The force of electrodes 52, 54 is sufficient to squish the brazing material out of the contact area between surface 14 and surface 49 and out of the contact area between surface 13 and surface 50, whereby this displaced material forms fillets 60 around the joints. A thin layer of the brazing material, having a thickness of about one to three atoms, remains in the two conductive interfaces, filling up the volumes created by any surface imperfections. The melting range for electroless nickel coatings varies depending upon the phosphorus content of the deposit. The present inventors have determined that when the deposited EN plating contains approximately fifteen percent phosphorous by mass, the melting point of such EN plating is around 1190 degrees Fahrenheit. By comparison, the melting point of copper is 1981 degrees Fahrenheit. As a result of this difference in melting points, all or almost all of the copper of conductor strip portions 25, 26 remains unmelted during the brazing operation. Typically, a small amount of the copper in the vicinity of terminal 9 alloys with the nickel. Most of the phosphorous burns away during the brazing, although some remains, and the resultant fillets may include a copper-nickel-phosphorous alloy. The finished color of these EN fillets is typically brownish in color and the fillets may lack the shine and attractiveness of a traditional EN surface. The phosphorous within EN plating 51 acts as a flux for the brazing, and no separate brazing flux is required.

The EN plating process and the brazing process may each minimize creation of alloys. For example, non-eutectoid compositions of nickel-phosphorous may be electrolessly plated onto terminal extensions 12, whereby phosphorous content may be increased to 15-18 percent. These very-high-phosphorous deposits have a reduced amorphous condition, and may contain a mixture of microcrystalline and amorphous phases. During brazing, as electroless nickel deposits are heated to temperatures above a threshold range of 420° to 500° F., structural changes begin to occur when coherent and then distinct particles of nickel phosphite (Ni 3P) may begin to form within the deposit. When temperatures become greater than about 600° F., the deposit begins to crystallize and begins to lose its amorphous character. When continued heating is performed relatively slowly, the nickel phosphite particles conglomerate and a two phase alloy forms. By comparison, when resistance brazing/welding is performed quickly and with a very-high phosphorous content, the alloying is minimized and/or may be controlled. At about 1620° F., the eutectic temperature of EN alloys, significant melting of the EN coating occurs, but the resultant alloying is localized at the faying surfaces and does not cause any significant deformation of the copper. By adjusting the force of electrodes 52, 54 as they press the layers (e.g., copper strip 25, terminal 9, copper strip 26) together, and by adjusting the modulation profile of electric current flowing through the mid-frequency resistance brazing machine, the time at which junction temperatures are above 1620° F. may be minimized and/or controlled. Process parameters may be adjusted to also minimize the thickness of nickel interface layers, whereby electrical resistivity at copper surfaces 49, 50 is not significant. The conductivity at the connection of terminal 9 and copper strips 25, 26 is further significantly increased by vaporization and/or migration of phosphorous during the brazing operation.

When alternator-starter 21 (e.g., FIG. 2) is functioning as an electric motor, for example for starting an ICE, the currents flowing through terminals 9 (e.g., FIG. 1) are very high, and can reach 1100 A or more. The brazed connections at terminals 9 as described above are corrosion resistant, uniform, relatively ductile, and include fillets 60 having strength and durability. Unlike traditional EN plating criteria, the EN coating properties prior to the brazing step may be otherwise undesirable. For example, a very-high phosphorous content in a finished product may create mechanical properties such as brittleness, stress cracks, flaking, and/or separation. However, these types of properties for very-high phosphorous EN plating do not adversely affect the brazing step, and the phosphorous content of the post-brazing EN material is greatly reduced. For example, one to three percent phosphorous by weight may be present in fillets 60, whereby the previous undesirable mechanical properties of the EN plating no longer exist, and where desirable mechanical properties such as adhesion, compressive stress, and ductility are improved.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A method, comprising resistance brazing using high-phosphorous electroless nickel (EN) plating both as a resistance path and as a flux.

2. A method for fixing an electrical terminal to a pair of copper conductor bus strips, comprising the steps of:
plating the electrical terminal with high-phosphorous electroless nickel (EN);
placing the EN-plated terminal between the bus strips; and
resistance brazing the terminal to the bus strips using the EN plating both as a resistance path and as a flux.

3. The method of claim 2, wherein the high-phosphorous electroless nickel used in the plating step includes approximately 15% phosphorous by weight.

4. The method of claim 2, wherein the plating step coats the terminal extension with high-phosphorous electroless nickel having a thickness of approximately 2.5 microns.

5. The method of claim 2, wherein the high-phosphorous electroless nickel has a melting point between about 1190 and 1350 degrees Farenheit.

6. A method of providing a high current electrical connection, comprising the steps of:
extending a terminal from a bottom surface of an electrical module;
plating the terminal extension with high-phosphorous electroless nickel;
placing a bus conductor into abutment with the plated terminal extension; and
resistance brazing the bus conductor to the plated terminal extension using the high-phosphorous electroless nickel as a resistance path.

7. The method of claim 6, wherein the bus conductor includes two substantially parallel conductor portions, wherein the placing step includes sandwiching the plated terminal extension between the two conductor portions, and wherein the brazing step includes placing two electrodes onto the respective two conductor portions.

8. The method of claim 7, further comprising biasing the electrodes toward one another.

9. The method of claim 8, further comprising adjusting force of the biasing to thereby adjust brazing heat at the resistance path.

10. The method of claim 9, further comprising adjusting brazing time and brazing electrical current to thereby obtain a copper nickel alloy at the terminal extension.

11. The method of claim 6, further comprising forming the terminal with a twist so that the terminal extension is substantially perpendicular to a remaining portion of the terminal.

12. The method of claim 6, wherein the high-phosphorous electroless nickel used in the plating step includes approximately 15% phosphorous by weight.

13. The method of claim 6, wherein the plating step coats the terminal extension with high-phosphorous electroless nickel having a thickness of approximately 2.5 microns.

14. The method of claim 6, wherein the high-phosphorous electroless nickel has a melting point between about 1190 and 1350 degrees Farenheit.

15. The method of claim 14, wherein the high-phosphorous electroless nickel has a melting point of about 1190 degrees Farenheit.

16. The method of claim 6, wherein the resistance brazing step includes applying a brazing current having a duration between about 0.1 to 0.4 seconds.

17. The method of claim 16, wherein the resistance brazing step includes applying a brazing current for about 0.25 second.

18. The method of claim 17, wherein the resistance brazing includes applying an adjustable force for pressing the bus conductors toward one another, and adjusting the force and a duration of the resistance brazing to maximize contact surface area between the bus conductors and the terminal extension.

19. The method of claim 6, wherein the resistance brazing includes applying an electrical current of between 6,000 and 15,000 amps through the bus conductors.

20. The method of claim 19, wherein the resistance brazing step includes applying an electrical current of about 1,250 amps per inch area.
